(19) United States
(12) Patent Application Publication
(10) Pub. No.: US 2010/0079379 A1
(43) Pub. Date: Apr. 1, 2010

(54) PORTABLE COMMUNICATION DEVICE HAVING AN ELECTROLUMINESCENT DRIVEN HAPTIC KEYPAD

(75) Inventors: Randolph C. Demuynck, Wake Forest, NC (US); William C. Eaton, Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/239,002

(22) Filed: Sep. 26, 2008

(51) Int. Cl. G06F 3/02; G06F 3/041

(52) U.S. Cl. 345/169; 345/173

(57) ABSTRACT

A portable communication device includes a touch-sensitive input device configured to provide haptic feedback. The touch-sensitive input device includes a touch-sensitive panel configured to detect user contact, an electroluminescent panel disposed below the touch-sensitive panel, and a haptic feedback panel disposed below the electroluminescent panel. The haptic feedback panel cooperates with the electroluminescent panel to provide haptic feedback upon detection of user contact with the touch-sensitive input device.

### TECHNICAL FIELD OF THE INVENTION

The present invention relates generally to portable communication devices, and more particularly, to a portable communication device having an electroluminescent driven haptic keypad

### DESCRIPTION OF RELATED ART

In recent years, portable communication devices, such as mobile phones, personal digital assistants, mobile terminals, etc., continue to grow in popularity. As the popularity of portable communication devices continues to grow, the applications for and features of portable communication devices continue to expand. Portable communication devices are appealing to users because of their capability to serve as powerful communication, data service and entertainment tools.

Most mobile phones include a liquid crystal display (LCD) to accommodate the information display requirements associated with today's mobile phones. In addition, touch-sensitive input devices, such as touch screens and touch keypads, have become popular. These devices allow for user input by touching the screen or other touch-sensitive area with a finger or stylus. Touch-sensitive keypads are useful for many applications in the mobile phone environment. Some benefits associated with touch-sensitive keypads include being thinner and easier to clean than mechanical buttons, allowing for easier sealing against water and environmental dirt, and providing reconfigurable button areas, e.g., soft keys, and permitting adaptable keypads.

### SUMMARY

To enhance functionality and versatility, a portable communication device is provided with a touch-sensitive input device configured to provide haptic feedback. The touch-sensitive input device includes a touch-sensitive panel, an electroluminescent panel operatively coupled to the touch-sensitive panel, and a haptic feedback assembly operatively coupled to the electroluminescent panel. The touch-sensitive input device is configured such that the haptic feedback assembly and the electroluminescent panel cooperate to provide localized haptic feedback responsive to the detection of a user's touch. The provision of such a touch-sensitive input device allows for a thin keypad that is equipped to provide haptic feedback.

One aspect of the disclosed technology relates to a portable communication device that includes a housing; and a touch-sensitive input device disposed within the housing. The touch-sensitive input device includes a touch-sensitive panel; an electroluminescent panel operatively coupled to the touch-sensitive panel; and a haptic feedback assembly operatively coupled to the electroluminescent panel, wherein the haptic feedback assembly is configured to provide haptic feedback upon detection of a user's touch on the touch-sensitive input device.

According to one feature, the touch-sensitive panel comprises a capacitive touch sensor that is configured to identify a location being touched by a user; and wherein the haptic feedback assembly is configured to provide haptic feedback proximal to the location.

According to one feature, the haptic feedback assembly comprises an electrostatic speaker.

According to one feature, the electrostatic speaker is formed by a portion of the electroluminescent panel.

According to one feature, the electrostatic speaker includes a PET (polyethylene terephathalate) sheet impregnated with ITO (Indium Tin Oxide) disposed between a pair of conductive elements.

According to one feature, one of the conductive elements is formed by a portion of the electroluminescent panel.

According to one feature, the electroluminescent panel is operatively coupled to drive circuitry, the drive circuitry being configured to selectively energize the electroluminescent panel; and wherein the electrostatic speaker is operatively coupled to the drive circuitry and selectively energized by the drive circuitry.

According to one feature, the electroluminescent panel is configured to include a plurality of selectively addressable segments; and at least one of the segments is used to selectively drive a portion of the electrostatic speaker.

According to one feature, the haptic feedback assembly comprises a piezoelectric member.

According to one feature, the piezoelectric member is selectively energizable by drive circuitry associated with the electroluminescent panel.

According to one feature, the touch-sensitive panel, the electroluminescent panel and the haptic feedback assembly have a collective thickness of less than about 0.5 millimeters.

According to one feature, the electroluminescent panel and the haptic feedback assembly cooperate to provide multi-modal feedback upon detection of a user's touch on a portion of the touch-sensitive input device.

According to one feature, the multi-modal feedback includes tactile feedback and audio feedback.

According to one feature, the multi-modal feedback includes visual feedback in the form of colored light.

According to one feature, the touch-sensitive input device is configured to be a dynamic keypad.

According to one feature, the portable communication device is a mobile telephone.

Another aspect of the disclosed technology relates to a touch-sensitive input device suitable for use in connection with a portable communication device. The touch-sensitive input device includes a touch-sensitive panel; an electroluminescent panel disposed below the touch-sensitive panel; and a haptic feedback assembly disposed below the electroluminescent panel, wherein the haptic feedback panel is configured to cooperate with the electroluminescent panel to provide haptic feedback.

According to one feature, the touch-sensitive panel comprises a capacitive touch sensor that is configured to identify a location being touched by a user; and wherein the haptic feedback assembly is configured to provide haptic feedback proximal to the location.

According to one feature, the haptic feedback assembly comprises an electrostatic speaker partially formed by the electroluminescent panel, the electrostatic speaker being selectively energizable by drive circuitry associated with the electroluminescent panel.

According to one feature, the haptic feedback assembly comprises a piezoelectric member that is selectively energizable by drive circuitry associated with the electroluminescent panel.

Another aspect of the disclosed technology relates to a capacitive sense, electroluminescent keypad for use in a portable communication device, where the keypad includes a haptic feedback assembly disposed below an electroluminescent panel, the haptic feedback assembly being configured to cooperate with the electroluminescent panel to provide localized haptic feedback upon detection of touch on the keypad.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a front view of a mobile phone including a touch-sensitive input device having haptic feedback as an exemplary portable communication device on which aspects of the technology may be carried out;

FIG. 2 is a block diagram of the exemplary portable communication device of FIG. 1;

FIG. 3 is a sectional view of a portion of an exemplary touch-sensitive input device;

FIG. 4A is a front view of an exemplary capacitive sense electroluminescent keypad;

FIG. 4B is a back view of the keypad of FIG. 4A;

FIG. 5 is a diagrammatic illustration of an electrostatic speaker employed in the haptic feedback assembly in accordance with one exemplary embodiment;

FIG. 6A is a diagrammatic illustration of a portion of an electroluminescent panel;

FIG. 6B is a diagrammatic illustration of the panel of FIG. 6A together with a haptic feedback assembly; and

FIG. 7 is a diagrammatic illustration of a portion of the touch-sensitive input device.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

As referred to herein, the term “portable communication device” includes portable radio communication equipment. The term “portable radio communication equipment”, which herein after is referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the disclosed technology is being discussed with respect to portable communication devices, it is to be appreciated that the invention is not intended to be limited to portable communication devices, and can be applied to any type of handheld mobile electronic equipment having a touch-sensitive input device.

In the context of the illustrated embodiments, the portable communication device is primarily referred to as a mobile telephone or a mobile phone. The description and illustrations of the mobile telephone, however, are intended to serve as a non-limiting exemplary environment for the inventive concepts described herein, and it will be appreciated that the invention is not intended to be limited to a mobile telephone, but rather can be any type of electronic equipment.

While features and functionality of mobile phones continue to increase, mobile phone designers struggle with phone size over function. Manufacturers and designers of mobile phones frequently seek to reduce the overall dimensions (e.g., footprint and overall thickness), while maintaining attractive style characteristics for the devices.

Touch-sensitive input devices (e.g., touch screens or touch keypads), are becoming more popular in portable communication devices. Touch-sensitive input devices provide numerous benefits, including thinner keypads that are easier to clean and easier to seal against contamination from water and dirt. Touch-sensitive input devices also allow for reconfigurable and adaptable keypads. Some touch-sensitive keypads may be configured to include capacitive touch sensors used in conjunction with electroluminescent (EL) panels. The use of this style keypad allows for a thinner mobile device, while at the same time providing a dynamic and adaptable user interface.

The present disclosure recognizes a problem with touch-sensitive input devices configured with a capacitive touch sensor together with EL panels. While such a keypad configuration allows for a thinner mobile device, there is no haptic feedback to the user of the mobile device.

In solving this problem, the disclosed portable communication device includes a thin touch-sensitive input device (e.g., a touch-sensitive keypad) configured to provide haptic feedback. The touch-sensitive input device is configured to include a touch-sensitive element and an electroluminescent panel together with a haptic feedback assembly. The touch-sensitive input device may be configured such that the haptic feedback assembly cooperates with the EL panel (e.g., is driven by the EL panel) to vibrate the input device in response to user touch. As such, the disclosed touch-sensitive input device provides all of the benefits of a thin keypad together with haptic feedback often found in larger and thicker mobile devices.

As is described more fully below, the portable communication device may be configured to provide multi-modal feedback, e.g., tactile feedback, audio feedback and/or visual feedback, in response to detection of a user touching the input device.

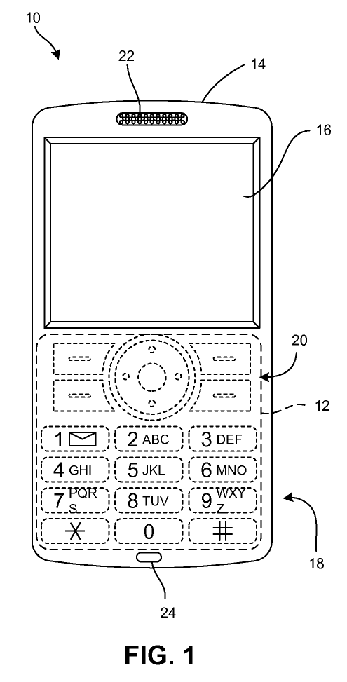

Referring initially to FIG. 1, an exemplary embodiment of a portable communication device 10 (e.g., a mobile phone, mobile terminal or the like) is shown. The mobile phone 10 is shown having a “block” or “candy bar” type of housing, but it will be appreciated that other form factors or housing types, such as, for example, a clamshell or slide-type housing may be utilized without departing from the scope of the present invention.

The mobile phone 10 includes a touch-sensitive input device 12 (e.g., a touch keypad) and a standard display 16 (e.g., a dedicated LCD display) disposed within a housing 14. In the illustrated embodiment, the mobile phone includes the touch-sensitive input device 12 being configured to include or otherwise display an alphanumeric keypad 18 together with functional or navigational keys 20. Of course, the touch-sensitive input device 12 may be adaptable and, as such, reconfigured to display other input prompts or keys depending on the particular mode in which the phone is being operated. For example, if the phone is being operated in a multimedia or gaming mode, the touch-sensitive input device 12 may be adaptively configured to show gaming controls and/or multimedia navigational controls. The illustrated mobile phones further include a speaker 22 and a microphone 24.

The display may be configured to display information to a user, such as recorded digital media, e.g., recorded photos and videos, operating state, time, phone numbers, contact information and various navigational menus, which enable the user to utilize the various features of the mobile phone 10. In addition, the touch keypad may be configured to receive user input via detection of user touch of the keypad, e.g., a touch by finger. As is described more fully below, the touch-sensitive input device is configured to provide haptic feedback (and possibly multi-modal haptic feedback) to a user upon detection of a user touch. In one embodiment, the touch-sensitive input device may include a touch-sensitive layer (e.g., a capacitive sense layer) disposed over or otherwise operatively coupled to an electroluminescent (EL) panel, which, in turn, is disposed over or otherwise operatively coupled to a haptic feedback assembly.

Artisans will appreciate that the mobile phone 10 further includes suitable circuitry and software for performing various functionality. The circuitry and software of the mobile phone is coupled with input devices, such as the alphanumeric keypad (alone or via the touch input display), the functional keys 20 and the microphone 24, as well as to the input/output devices, including the touch-sensitive input device 12 and the speaker 22. It will be appreciated that the touch-sensitive input device may have any suitable size, shape and positioning without departing from the scope of the present invention.

The functional and/or navigational keys 20 may provide for a variety of user input operations. For example, the functional keys 20 typically include special function keys, such as a “call send” key for initiating or answering a call, and a “call end” key for ending or “hanging up” a call. Special function keys also may include menu navigation keys, for example, for navigating through a menu displayed on the display(s) to select different telephone functions, profiles, settings, etc., as is conventional. Other navigational keys or controls may include directional keys (e.g., up, down, left, and right) to highlight different links, or icons, or to navigate text or other documents, etc. Other keys associated with the mobile telephone may include a volume key, an audio mute key, an on/off power key, a web browser launch key, a camera key and the like. The navigational keys may be embodied as “hard keys” or “soft keys” implemented on a touch-sensitive input device.

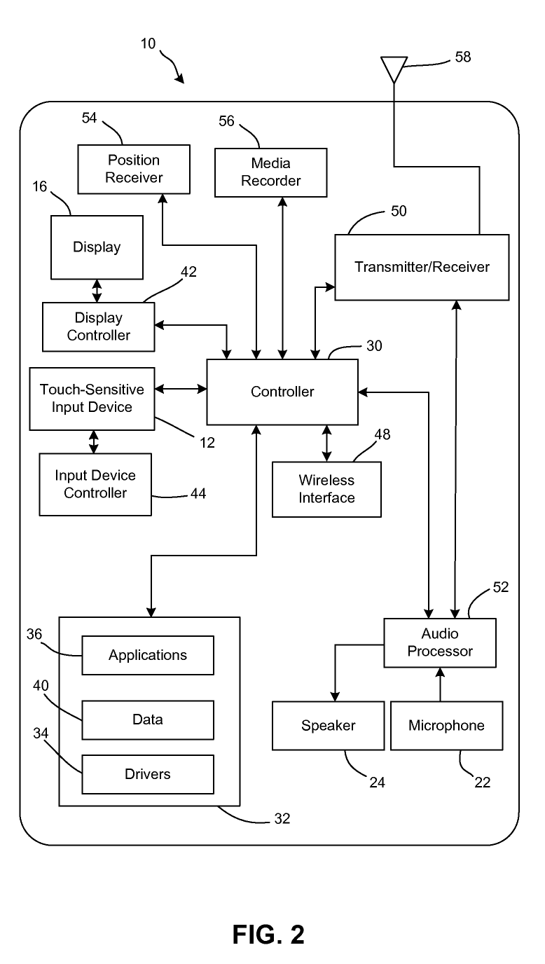

FIG. 2 represents a functional block diagram of a portable communication device 10. The portable communication device 10 includes a controller 30 that controls the overall operation of the portable communication device. The controller 30 may include any commercially available or custom microprocessor or microcontroller. Memory 32 is operatively connected to the controller 30 for storing control programs and data used by the portable communication device. The memory 32 is representative of the overall hierarchy of memory devices containing software and data used to implement the functionality of the portable communication device in accordance with one or more aspects described herein. The memory 32 may include, for example, RAM or other volatile solid-state memory, flash or other non-volatile solid-state memory, a magnetic storage medium such as a hard disk drive, a removable storage media, or other suitable storage means. In addition to handling voice communications, the portable communication device 10 may be configured to transmit, receive and process data, such as web data communicated to and from a web server, text messages (also known as short message service or SMS), electronic mail messages, multimedia messages (also known as MMS), image files, video files, audio files, ring tones, streaming audio, streaming video, data feeds (e.g., podcasts) and so forth.

In the illustrated embodiment, memory 32 stores drivers 34 (e.g., I/O device drivers), application programs 36, and application program data 40. The I/O device drivers include software routines that are accessed through the controller 30 (or by an operating system (not shown) stored in memory 32) by the application programs, to communicate with devices such as the touch-sensitive input device 12 and the navigation keys 20 adaptively displayed on the touch-sensitive input device, as well as other input/output ports. In one embodiment where the mobile phone includes a dedicated display 16, the display 16 may be operatively coupled to and controlled by a display controller 42 (e.g., a suitable microcontroller or microprocessor). In a preferred embodiment, the touch-sensitive input device 12 is operatively coupled to and controlled by an input device controller 44 (e.g., a suitable microcontroller or microprocessor) and configured to facilitate touch input functionally (detection of user touch of the display and recognition of desired user input based on the touch of the display). Further, the input device controller 44 facilitates the haptic feedback features associated with the touch-sensitive input device. It will be appreciated that the input device controller functionality 44 also could be carried out via dedicated hardware, firmware, software or combinations thereof without departing from the scope of the present invention.

With continued reference to FIG. 2, the controller 30 interfaces with the aforementioned touch-sensitive input device 12 (and any other user interface device(s)), a transmitter/receiver 50 (often referred to as a transceiver), audio processing circuitry, such as an audio processor 52, and a position determination element or position receiver 54, such as a global positioning system (GPS) receiver. The portable communication device 10 may include a media recorder 56 (e.g., a still camera, a video camera, an audio recorder or the like) that captures digital pictures, audio and/or video. Image, audio and/or video files corresponding to the pictures, songs and/or video may be stored in memory 32.

An antenna 58 is coupled to the transmitter/receiver 50 such that the transmitter/receiver 50 transmits and receives signals via antenna 58, as is conventional. The portable communication device includes an audio processor 52 for processing the audio signals transmitted by and received from the transmitter/receiver. Coupled to the audio processor 52 are the speaker 22 and microphone 24, which enable a user to listen and speak via the portable communication device. Audio data may be passed to the audio processor 52 for playback to the user. The audio data may include, for example, audio data from an audio file stored in the memory 32 and retrieved by the controller 30. The audio processor 52 may include any appropriate buffers, decoders, amplifiers and the like.

The portable communication device also may include one or more local wireless interfaces, such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the portable communication device 10 to the adapter, another mobile radio terminal, a computer, or any other electronic device. Also, the wireless interface may be representative of an interface suitable for communication within a cellular network or other wireless wide-area network (WWAN).

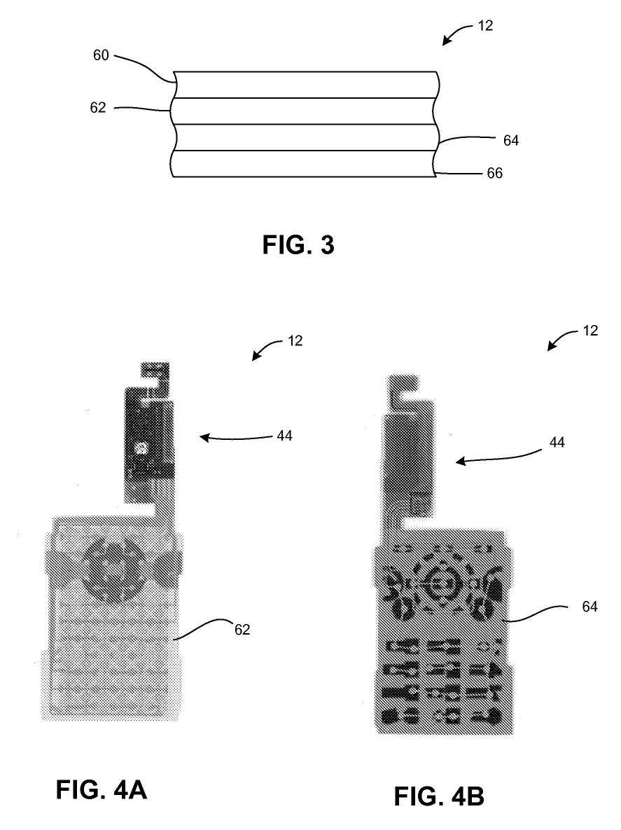

Turning now to FIG. 3-FIG. 7, the touch-sensitive input device 12 is configured to provide the thin profile and functionality associated with a capacitive sense element and an electroluminescent (EL) panel in conjunction with a haptic feedback assembly. FIG. 3 shows a cross-section of an exemplary touch-sensitive input device 12. A cover portion 60 (e.g., a clear plastic cover) is disposed over the touch-sensitive input device 12. The touch-sensitive input device 12 includes a touch-sensitive panel or member 62 (e.g., a capacitive touch sensor) that is operative to detect a localized position of a user touching the device 12. An electroluminescent (EL) panel 64 is disposed below or otherwise operatively coupled to the touch-sensitive panel 62. A haptic feedback assembly 66 is disposed below or otherwise operatively coupled to the electroluminescent panel 64. It will be appreciated that, as used herein, “below” includes a member/panel being directly below another member/panel or being separated by one or more intervening layers.

FIGS. 4A and 4B show front and back views, respectively, of an exemplary capacitive sense 62 portion and EL portion 64 of a touch-sensitive keypad 12 along with the control/drive circuitry 44. As is described more fully below, this type of keypad may be configured such that the EL panel is wired or otherwise configured to include a number of individually-addressable segments that can be selectively energized. The EL panel may include a plurality of panel regions that can be activated separately or simultaneously. The panel regions can be different in shape and size and may form a pattern that can be used to create animations and dynamic or adaptive keypads.

A typical EL panel may include a thin emission layer including an EL phosphor (a compound that emits light when excited by an electrical field) in a dielectric substrate disposed between two thin electrically conductive electrode layers. By applying a high voltage across two electrode layers, an electric field may be induced in between them. The phosphor is thereby excited to a higher energy state. When the electric field is removed, the atoms fall back to a lower energy state, emitting photons as visible light in the process. It will be appreciated that a variety of EL assemblies may be employed. For example, one suitable EL assembly may include a Pelikon pSEL assembly. This type of EL panel is printed onto sheets of PET (polyethylene terephathalate) coated with a transparent conductive material, such as ITO (Indium Tin Oxide). The Pelikon pSEL assembly may include a high voltage driver, e.g., a Pelikon fourteen channel segment driver, designed to allow individual control of a number of small areas of electroluminescent phosphor. Of course, it will be appreciated that other EL panels or assemblies may be employed without departing from the scope of the present invention.

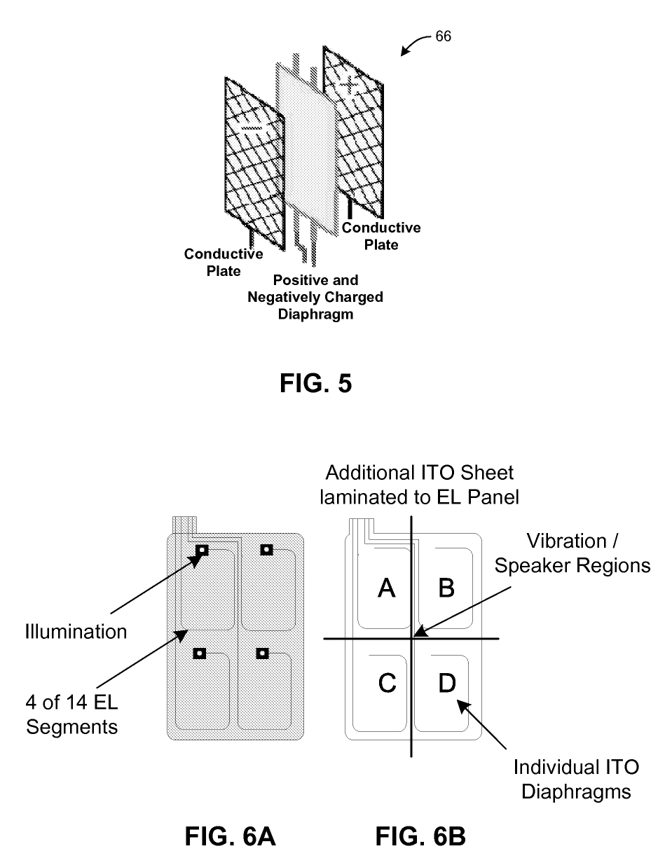

In one embodiment, the haptic feedback assembly 66 may include formation of an electrostatic speaker that is used to vibrate the combined capacitive sense EL keypad. The electrostatic speaker may be formed in a variety of different manners without departing from the scope of the present invention. For example, in one embodiment, the electrostatic speaker is created by placing an additional sheet of PET embedded with ITO to the bottom of the keypad and using the EL panel to drive the audio circuit. In general, it will be appreciated that an electrostatic speaker typically uses a thin flat diaphragm including a plastic sheet, such as PET impregnated with a conductive material ITO, sandwiched or otherwise disposed between two electrically conductive grids (see FIG. 5, for example) with a small air gap between the diaphragm and grids. By means of the conductive coating and an external high voltage supply, the diaphragm may be held at a DC potential of several kilovolts with respect to the grids. The grids are driven by the audio signal and result in a uniform electrostatic field proportional to the audio signal between both grids. This causes a force to be exerted on the charge diaphragm, and its resulting movement drives the air on either side of it. Typical electrostatic assemblies are driven at one kilovolt or greater. In one embodiment, the electrostatic assembly may be driven in the range of the EL driver (e.g., in the range of about two-hundred volts). In this case, to actuate a movement or click, all that is needed is to deliver an on/off event via a driver (such as the EL driver). It will be appreciated that in this embodiment, the EL panel 64 cooperates to form a portion of the haptic feedback assembly, for example, by serving as one of the grids. Other configurations may be employed without departing from the scope of the present invention.

In an alternate embodiment, the haptic feedback assembly 66 may be formed by use of a piezoelectric membrane or piezoelectric film as the basis of the sound/vibration mechanism. It will be appreciated that piezoelectric film transducers may offer wide dynamic range and also are broadband. One suitable material is PVDF (polyvinylidene fluoride), which can be found by the commercial names KYNER, HYLAR, or SYGEF. In the piezoelectric embodiment, it is possible to obtain deflection caused by the applied voltage to the piezoelectric layer. It also is possible to include some structure or relief so that there is room for deflection, (e.g., 0.1 millimeters). As is described more fully below, there may be individual pockets created in the EL panel assembly to accomplish this.

In the embodiment in which the haptic feedback device comprises an electrostatic speaker, the output of the electrostatic speaker may include an audible click sound and vibrate the keypad in the particular focus area. The focus areas may be created by using a predetermined number of the predefined segments of the EL panel 64, for example, by using four of the fourteen segments of the EL panel.

FIGS. 6A and 6B illustrate the use of the EL panel 64 in conjunction with an ITO sheet or (PVDF layer) to create four distinct haptic feedback regions (labeled as A, B, C and D in FIG. 6B). When the user selects an area on the keypad (as determined by the capacitive sensor or other touch-sensitive sensor), the software may determine the coordinates and energize the correct region to provide localized haptic feedback. In one embodiment, each of the four areas may also be coupled with a color. In this embodiment, the haptic feedback assembly may be configured to provide multi-modal feedback to the user such that the feedback may include light, sound and/or vibration upon the user's touch on a portion of the keypad.

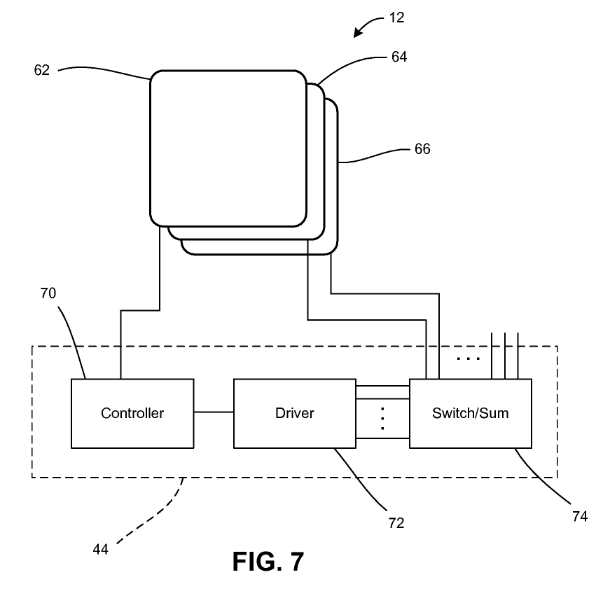

Turning now to FIG. 7, a simplified diagram shows operation of the touch-sensitive input device 12 and control of the touch-sensitive input device 12 by the input device control circuitry 44. In operation, a user's touch may be sensed by the capacitive touch sensor 62, thereby generating a touch signal which is received by a controller 70, causing a driver 72 to respond and turn on one of several voltage outputs by way of a switch assembly 74. EL light can then be turned on and/or a click/vibration may be actuated at the same time or independently by control signal operated switching.

The provision of a mobile phone having a touch-sensitive input device equipped with haptic feedback provides enhanced functionality and versatility. For example, in the case of the capacitive sense/EL keypad, a very thin keypad (e.g., on the order of 0.5 millimeters, 0.4 millimeters or less) may be provided along with the benefits associated with haptic feedback. Further, the device may be configured to provide multi-modal feedback in that light, audio and/or vibration feedback may be generated upon detection of the user's touch on a portion of the keypad. By incorporating a haptic feedback assembly that cooperates with and/or is driven by the existing EL panel, overall construction and/or manufacture is simplified. Further, this extra functionality is provided in an extremely thin profile keypad.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable communication device comprising:
a housing; and
a touch-sensitive input device disposed within the housing, the touch-sensitive input device comprising:
a touch-sensitive panel;
an electroluminescent panel operatively coupled to the touch-sensitive panel; and
a haptic feedback assembly operatively coupled to the electroluminescent panel, wherein the haptic feedback assembly is configured to provide haptic feedback upon detection of a user's touch on the touch-sensitive input device.

2. The portable communication device of claim 1, wherein the touch-sensitive panel comprises a capacitive touch sensor that is configured to identify a location being touched by a user; and wherein the haptic feedback assembly is configured to provide haptic feedback proximal to the location.

3. The portable communication device of claim 1, wherein the haptic feedback assembly comprises an electrostatic speaker.

4. The portable communication device of claim 3, wherein the electrostatic speaker is formed by a portion of the electroluminescent panel.

5. The portable communication device of claim 3, wherein the electrostatic speaker includes a PET (polyethylene terephathalate) sheet impregnated with ITO (Indium Tin Oxide) disposed between a pair of conductive elements.

6. The portable communication device of claim 5, wherein one of the conductive elements is formed by a portion of the electroluminescent panel.

7. The portable communication device of claim 3, wherein the electroluminescent panel is operatively coupled to drive circuitry, the drive circuitry being configured to selectively energize the electroluminescent panel; and
wherein the electrostatic speaker is operatively coupled to the drive circuitry and selectively energized by the drive circuitry.

8. The portable communication device of claim 7, wherein the electroluminescent panel is configured to include a plurality of selectively addressable segments; and at least one of the segments is used to selectively drive a portion of the electrostatic speaker.

9. The portable communication device of claim 1, wherein the haptic feedback assembly comprises a piezoelectric member.

10. The portable communication device of claim 9, wherein the piezoelectric member is selectively energizable by drive circuitry associated with the electroluminescent panel.

11. The portable communication device of claim 1, wherein the touch-sensitive panel, the electroluminescent panel and the haptic feedback assembly have a collective thickness of less than about 0.5 millimeters

12. The portable communication device of claim 1, wherein the electroluminescent panel and the haptic feedback assembly cooperate to provide multi-modal feedback upon detection of a user's touch on a portion of the touch-sensitive input device.

13. The portable communication device of claim 12, wherein the multi-modal feedback includes tactile feedback, audio feedback and/or visual feedback in the form of colored light.

14. The portable communication device of claim 1, wherein the touch-sensitive input device is configured to be a dynamic keypad.

15. The portable communication device of claim 1, wherein the portable communication device is a mobile telephone.

16. A touch-sensitive input device suitable for use in connection with a portable communication device, the touch-sensitive input device comprising:
a touch-sensitive panel;
an electroluminescent panel disposed below the touch-sensitive panel; and
a haptic feedback assembly disposed below the electroluminescent panel, wherein the haptic feedback panel is configured to cooperate with the electroluminescent panel to provide haptic feedback.

17. The touch-sensitive input device of claim 16, wherein the touch-sensitive panel comprises a capacitive touch sensor that is configured to identify a location being touched by a user; and wherein the haptic feedback assembly is configured to provide haptic feedback proximal to the location.

18. The touch-sensitive input device of claim 16, wherein the haptic feedback assembly comprises an electrostatic speaker partially formed by the electroluminescent panel, the electrostatic speaker being selectively energizable by drive circuitry associated with the electroluminescent panel.

19. The touch-sensitive input device of claim 16, wherein the haptic feedback assembly comprises a piezoelectric member that is selectively energizable by drive circuitry associated with the electroluminescent panel.

20. A capacitive sense, electroluminescent keypad for use in a portable communication device, the keypad comprising:
a haptic feedback assembly disposed below an electroluminescent panel, the haptic feedback assembly being configured to cooperate with the electroluminescent panel to provide localized haptic feedback upon detection of touch on the keypad.
